(19) United States
(12) Patent Application Publication
(10) Pub. No.: US 2009/0008968 A1
(43) Pub. Date: Jan. 8, 2009

(54) Closure Device for a Convertible Top of a Convertible Vehicle

(75) Inventors: Klaus Russke, Bissendorf (DE); Heinrich Selle, Bad Oeynhausen (DE); Birgit Metzner, Hagen (DE)

Correspondence Address: QUINN LAW GROUP, PLLC, 39555 ORCHARD HILL PLACE, SUITE # 520, NOVI, MI, 48375, US

(73) Assignee: WILHELM KARMANN GMBH, Osnabruck (DE)

(21) Appl. No.: 10/599,490

(22) PCT Filed: Mar. 31, 2005
(86) PCT No.: PCT/DE2005/000582

§ 371 Date: Sep. 15, 2008

(30) Foreign Application Priority Data
Apr. 2, 2004 (DE) 20 2004 005 257.1

(51) Int. Cl. B60J 7/185

(52) U.S. Cl. 296/224

(57) ABSTRACT

A closure device to close a convertible top of a convertible vehicle onto a body frame part, wherein at least one closure element is connected to the convertible top and at least one mating closure element is connected to the body frame part, which can be engaged by means of a motor drive unit. The convertible top has a handle element, by which the convertible top can be moved manually between a pre-closure position at a spacing from the body-frame part and a catching position, in which the convertible top can be closed. The closure device includes a sensor, by which assumption of the catching position of the convertible top is detectable and which sends signals to a control unit of the drive unit.

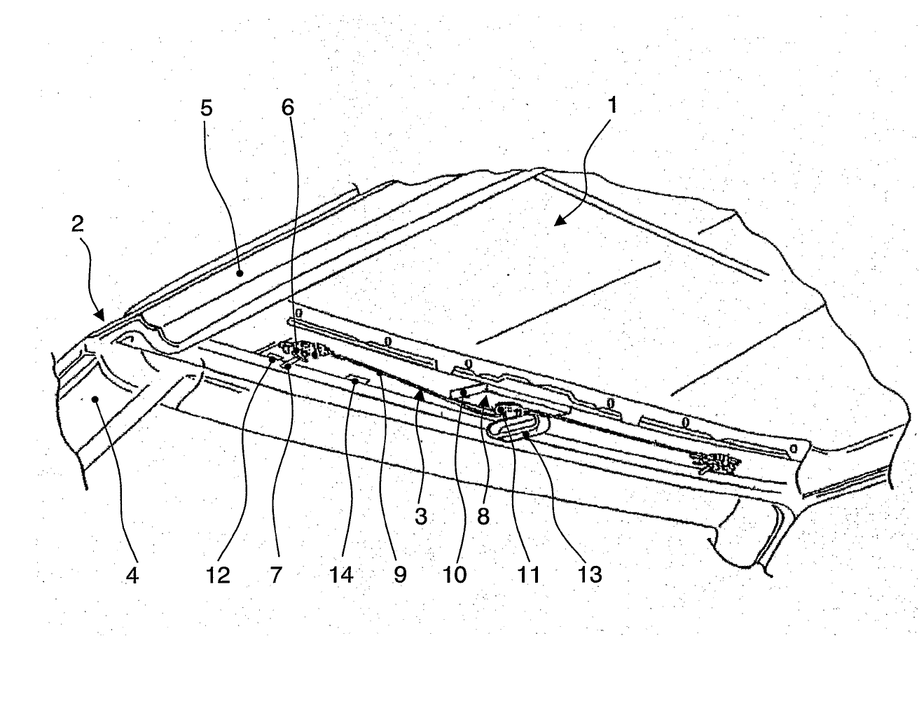

### CROSS-REFERENCE TO RELATED APPLICATION(S)

This application is a US National Phase of International Application No. PCT/DE 2005/000582, filed Mar. 3, 2005, which claims priority to German 20 2004 005 257.1, filed Apr. 2, 2004. The entire contents of the above identified applications are incorporated herein by reference.

### TECHNICAL FIELD

The invention relates to a closure device to close a convertible top of a convertible vehicle, as well as to a convertible top of a convertible vehicle with such a closure device.

### BACKGROUND OF THE INVENTION

Closure devices are used, in practice, in convertible vehicles, in order to attach the convertible top in the closed state to an auto-body frame part, usually a windshield frame. Manual and fully automatic closure devices are known.

A closure device to be operated manually for a convertible top of a convertible vehicle is known, for example, from EP 0 850 793 B1, whereby this closure device has closure elements arranged in side areas of the convertible top or windshield frame and an operating device is arranged between the closure elements in the center, in order to attach the convertible top to the frame part. For this purpose, a mechanism is provided between the closure elements and the operating device, so that, depending on rotation of the operating device, the closure elements engage with mating closure elements and thereby attach the convertible top or release it, thus permitting an opening movement of the convertible top.

In one such closure device, operation of the operating device for attaching the convertible top must occur in a specified position of the convertible top, so that the closure elements engage with the mating closure elements and, at the same time, rotation of the operating device must occur with a necessary force into an assignable end position, so that the convertible top is securely attached. Rotation of the operating device is accordingly necessary for unlocking.

The manual operating processes in a closure device for convertible tops according to the above-mentioned prior art therefore require rotation of the operating device, which is to be achieved by a manual movement. This rotational movement for the operator of the operating device is executed by a rotational movement of the hand, so that locking and unlocking of the convertible top requires a significant operating effort, which can be perceived as uncomfortable and could require significant exertion of force for operation.

Convertible tops that close fully automatically are also known in practice. A problem here is that, because of the tolerances of the convertible-top mechanism or the convertible-top material, especially in a convertible-top fabric, or because of stresses in the convertible top, the closed position or a pre-closed position can vary from vehicle to vehicle and even in one vehicle. Compensation for these tolerances is therefore necessary, which further increases the design expense, which is substantial in any case in a fully automatic closure mechanism.

### SUMMARY OF THE INVENTION

A task of the present invention is therefore to devise a closure mechanism that can be comfortably operated relative to the known closure devices, requires limited operating effort, and can occur with limited force. Another task of the invention is to devise a closure mechanism that is as insensitive as possible to tolerances of the convertible top.

This task is solved according to the invention with a closure device to close a convertible top of a convertible vehicle onto a body frame part; in which at least one closure element is allocated to the convertible top and at least one mating closure element is allocated to the body frame part, which can be engaged by means of a motor drive unit; in which the convertible top has a handle element, by means of which the convertible top can be moved manually between a pre-closure position at a spacing from the vehicle frame part and a locking position, in which the convertible top is closable; and in which the closure device includes a sensor, by means of which assumption of the catching position of the convertible top is detectable and which sends signals to a control unit of the drive unit.

The convertible top can be transferred in an automated manner (electrically or hydraulically), or also manually, into or from the pre-closure position. For closure, the convertible top must be positioned in the catching position, which can be pre-defined, and it can be both a position that activates the drive unit directly before reaching a stop position on the body-frame element and the attached position itself.

For manual closure of the convertible top, only the roof peak of the convertible top needs be pulled manually into the locking position. The handle element is appropriately provided in the roof peak of the convertible top for this purpose or in a lining of the roof peak of the convertible top. The handle element is, for example, a grip bowl, preferably a non-rotatable handle or similar device. This makes it possible to close the convertible top simply.

When the locked position is reached, the sensor provided for this purpose detects this and sends a corresponding signal to a control unit of the drive unit, which, based on this signal, activates at least one closure element or mating closure element.

With the closure device according to the invention, a simpler, facilitated locking of the convertible top is advantageously achieved compared to known manual closure devices, since the convertible top needs only to be pulled down manually from a pre-closure position into the locking position, the previously required and sometimes very demanding rotational movement of an operating hand being eliminated here. Operation therefore requires a significantly reduced effort on the part of the operating person relative to known, purely mechanical solutions with rotatable operating devices.

At the same time, in contrast to fully automatic solutions, the advantages of limited design expense and simple tolerance compensation are provided.

According to a preferred embodiment of the invention, two closure elements arranged symmetrically to the center axis of a vehicle on the convertible top and mating closure elements corresponding to them are provided on the body-frame part.

The device according to the invention also includes an operating element, based on whose operation, at least in the attached state of the convertible top, the drive unit can be controlled to operate the at least one closure element to release the convertible top. For this purpose, an operating element that is easy to operate manually is provided, for example, a pushbutton, toggle switch, contact sensor, etc. By operating the operating element, the control unit sends a signal, whereupon the drive unit is operated in order to operate the closure element and to disengage the closures elements from the mating closure elements, so that the closure device is unlocked. In this state, the convertible top can then be opened fully, manually or automatically.

The sensor provided according to the invention to detect achievement of the locked position can be a switch, such as a contact switch or a micro-switch. The sensor in another embodiment example of the invention can also be designed as a contactless sensor or switch, for example, a REED switch or optical sensor.

The drive unit provided according to the invention activates the closure elements by pivoting them with, for example, a mechanical connection device. The device can advantageously be designed for this purpose as an electrically drivable unit. Such a unit is preferably an electric motor. In case the closure device has two closure elements, a gear mechanism is appropriately connected with the electric motor, which converts the rotational movement of the motor output shaft to a displacement movement of two mechanical connection devices.

According to another embodiment of the invention, the drive unit of the closure device can be configured as a hydraulically driven unit. The hydraulic drive unit can then have an output element that operates the closure elements by means of connection devices. Then a gear mechanism can also be provided that converts the operating movement of an output element of the drive unit to a displacement movement of two mechanical connection devices. Two output elements of the drive unit can also be provided, each of which operates a closure device by means of a connection device.

It is appropriate if the drive unit is integrated into the closure device, whereby it is again advantageously integrated into the convertible top when it operates the closure elements, and integrated into the body-frame part, when it operates the mating closure elements. Preferably, the drive unit, in a device with two closure elements and mating closure elements, is arranged between the closure elements and mating closure elements.

Additional advantages and advantageous embodiments of the object of the invention can be seen from the description, the drawing, and the claims.

### BRIEF DESCRIPTION OF THE DRAWING

An embodiment example of a convertible top according to the invention is shown schematically simplified in the drawing and is explained further in the following description.

The single diagram in the drawing shows, in a schematic, three-dimensional view, a cutout of a convertible top of a convertible vehicle with a closure device according to the invention, shown simplified.

### DESCRIPTION OF THE PREFERRED EMBODIMENT

Referring to the FIGURE of the drawing, a convertible top 1 of a convertible vehicle 2, shown only partly, is shown in a closed state, in which it is attached by means of a closure device 3 to a body frame part 4, which is here represented by a windshield frame.

The closure device 3 has two closure elements 6 arranged on a roof peak or convertible-top front edge 5 laterally and symmetric with respect to the center longitudinal axis of a vehicle, which can be engaged with mating closure elements 7 on the windshield frame or body frame part 4, which, in practice, lie behind a lining and are only indicated, in principle, in the diagram, in order to attach the convertible top to the windshield frame 4.

The closure device 3 also has a drive unit 8 arranged essentially between the closure elements 6, which is provided in this case to operate the closure elements 6.

It is understood that in another variant, instead of a drive of the closure elements, a drive of the mating closure elements can also be provided.

The drive unit 8 is preferably controlled electrically or electronically. For this purpose, an electronic control unit (not further shown in the diagram) is provided, which in the present case is integrated into the closure device 3, but in another embodiment according to the invention, it can also be arranged separately.

Connection elements 9 are provided between the drive unit 8 and the closure elements 6, in order to achieve a drive connection between the closure elements 6 and the drive unit 8 by a mechanical coupling. The connection elements 9 in the present case are designed as hinged connection rods, but in other variants they can also be designed as other drive rods, pull cables, etc.

In the embodiment shown, the drive unit 8 is designed with an electric motor 10, but the drive unit, as an alternative, can be designed, for example, as a hydraulic unit.

In the present case, a gear mechanism 11 is arranged after a motor-output shaft of the electric motor 10, which simultaneously establishes the speed of the electric motor 10 and transforms a rotational movement of the output shaft into an axial movement of the connection elements 9. This preferably occurs by means of a step-down gear, such as a worm gear or gear train, that transfers the rotational movement of the motor-output shaft to a worm gear or output gear, on which hinged linkages of the two connection elements 9 are provided, in order to cause an essentially axial movement of the connection elements 9 from the rotational movement of the output gear.

The closure elements 6 represent hook-like locking elements which have an interacting connection with the connection elements or connection rods 9, and which can be engaged with the mating closure elements 7 (designed as pins here) during rotation or tilting of the convertible top 1 into a catching position. Tilting is achieved in that, during a rotational movement of the motor output shaft, the connection elements 9 are displaced in the axial direction, during which the closure elements or locking elements 6 connected to the connection elements 9 are tilted or rotated about an axis, in order to engage with the mating closure elements 7.

Linkage of the connection elements 9 to the locking elements 6 can then occur in a known fashion, for example as described in EP 0 850 793 B1, through a lever arm on which both the corresponding connection element 9 and the corresponding closure or locking elements 6 are mounted so as to move by means of articulations. The tensile force transferred to the connection elements 9 by the motor-output shaft and their action by means of the levers on the closure element 6 cause engagement with the mating closure elements 7.

The control unit of the drive unit 8 is signal-connected to a sensor 12, which detects whether the convertible top 1 has assumed a specified position, which is defined as the locked position. If reaching of the catching position by the convertible top is detected, this is sensed by sensor 12 and processed by the control unit. The control unit then operates the drive unit 8, in order to engage the closure element 6 with the mating closure elements 7 and attach the convertible top 1 to the windshield frame 4.

The procedure of a closure process for the convertible top 1 therefore occurs as follows: the convertible top 1 is transferred from an open position to a pre-closure position. This closing can occur manually, or also in an automated manner, depending on the design of the convertible top 1. In the pre-closure position, the roof peak or convertible-top front edge 5 is raised at a specified spacing with respect to the rear edge of the windshield frame 4.

If the convertible top 1 is to be fully closed and attached, the convertible top 1, with the front edge 5, is guided manually, for example, overcoming a dead center on the windshield frame 4, until the catching position is assumed. Reaching of the catching position is detected by the sensor 12, which is in signal connection with the control unit of the drive unit 8, whereupon the control unit operates the drive unit 8, in order to activate the closure element 6 for locking. The convertible top 1 is thereby attached.

For manual closure of the convertible top 1, the convertible top 1, in the catching position, has a gripping element 13, which is designed as a grip, and in the simplest variant it can also be designed as a grip plate.

To unlock the convertible top 1, the closure device 3 includes an operating element 14. This operating element 14, in the present case, is designed as a pushbutton, and it is also in signal connection with the control unit of the drive unit 8. During operation of the operating element 14, on receiving the operating signal, the drive unit 8 is operated in order to release the convertible top 1 by driving the closure elements 6, in which case the closure elements 6 are disengaged from the mating closure elements 7.

For this, the motor output shaft is rotated, in the state attached to the windshield frame 4, in the opposite rotational direction, or a rotational movement is caused by the gear mechanism 11, during which a pushing force, acting essentially in the axial direction, is exerted on the connection elements 9, which causes tilting of the closure or locking elements 6, in order to disengage them from the mating closure elements 7. The convertible top 1 can then be opened completely, manually or automatically.

While the best modes for carrying out the invention have been described in detail, those familiar with the art to which this invention relates will recognize various alternative designs and embodiments for practicing the invention within the scope of the appended claims.

### REFERENCE NUMBERS

1 Convertible top
2 Convertible vehicle
3 Closure device
4 Body-frame element, windshield frame
5 Roof peak, convertible-top front edge
6 Closure element, locking element
7 Mating closure element
8 Drive unit
9 Connection element
10 Electric motor
11 Gear mechanism
12 Sensor
13 Handle element
14 Operating element

1. A closure device to close a convertible top (1) of a convertible vehicle (2) onto a body frame part (4), wherein at least one closure element (6) is connected to the convertible top (1) and at least one mating closure element (7) is connected to the body frame part (4), which can be engaged by means of a motor drive unit (8), and the convertible top (1) has a handle element (13), by which the convertible top (1) can be moved manually between a pre-closure position at a spacing from the body-frame part (4) and a catching position, in which the convertible top (1) is closable, and wherein the closure device (3) includes a sensor (12), by which assumption of the catching position of the convertible top (1) is detectable and which sends signals to a control unit of the drive unit (8).

2. A closure device according to claim 1, characterized in that the sensor (12), on reaching of the catching position of convertible top (1), generates a signal, and the control unit, based on the recorded signal of sensor (12) actuates the drive unit (8) to activate at least one closure element (6) and/or mating closure element (7) to attach the convertible top (1).

3. A closure device according to claim 1, characterized in that two closure elements (6) are provided on the convertible top (1) and two mating closure elements (7) on the body-frame part (4).

4. A closure device according to claim 1, characterized in that it includes an operating element (14), based on whose operation, at least in the attached state of the convertible top, a signal is generated, and the drive unit (8) is operated to release the convertible top (1).

5. A closure device according to claim 1, characterized in that to release the convertible top (1), operation of at least one closure element (6) occurs, so that the closure element (6) is disengaged from the corresponding closure mating

6. A closure device according to claim 1, characterized in that the sensor (12) is designed as a switch, especially as a microswitch.

7. A closure device according to claim 1, characterized in that the drive unit (8) is designed as an electrically drivable unit, especially with an electric motor (10).

8. A closure device according to claim 1, characterized in that the drive unit is a hydraulically driven unit.

9. A closure device according to claim 1, characterized in that the drive unit (8) is integrated into the closure device (3).

10. A closure device according to claim 1, characterized in that the drive unit is integrated into the body frame part.

11. A convertible top for a convertible vehicle with a closure device (3) for releasable attachment of the convertible top (1) to a body frame part (4) according to claim 1.
